(19) United States
(12) Patent Application Publication
(10) Pub. No.: US 2009/0243281 A1
(43) Pub. Date: Oct. 1, 2009

(54) CONNECTORS HAVING FEATURES TO FACILITATE OR HAMPER TIGHTENING AND/OR LOOSENING

(75) Inventors: John Seifert, Coventry, CT (US); Mark Lindsay, Ashford, CT (US); Jeffrey Woods, Stafford Springs, CT (US)

Correspondence Address: KNOBBE MARTENS OLSON & BEAR LLP, 2040 MAIN STREET, FOURTEENTH FLOOR, IRVINE, CA, 92614, US

(73) Assignee: ICU Medical INC., San Clemente, CA (US)

(21) Appl. No.: 12/412,192

(22) Filed: Mar. 26, 2009

Related U.S. Application Data
(60) Provisional application No. 61/040,326, filed on Mar. 28, 2008.
(60) Provisional application No. 61/150,659, filed on Feb. 6, 2009.

(51) Int. Cl. F16L 35/00

(52) U.S. Cl. 285/38

(57) ABSTRACT

A connector includes gripping features. The gripping features can comprise two surfaces that generally oppose each another. Each surface can be configured to facilitate or hamper rotation of the connector in a direction. Some embodiments can hamper tightening and facilitate loosening of the connector. Other embodiments can facilitate tightening and hamper loosening. Still other embodiments can hamper both tightening and loosening. Yet other embodiments can facilitate both tightening and loosening.

### RELATED APPLICATIONS

This application claims the benefit under 35 U.S.C. §119(e) to U.S. Provisional Patent Application No. 61/040,326, filed Mar. 28, 2008, and U.S. Provisional Patent Application No. 61/150,659, filed Feb. 6, 2009, each of which is incorporated by reference herein in its entirety.

### BACKGROUND

1. Field of the Disclosure

The present disclosure relates generally to connectors, and more particularly to rotatable connectors.

2. Description of the Related Art

Various connectors are used to connect medical devices. For example, connectors can be used in fluid delivery systems to connect syringes, catheters, lumens, tubes, or other devices. Such connectors generally aim to create a sealed environment between connectors and establish fluid communication between the connectors. It is generally desirable for such connectors to also be disconnectable. Among the connectors used in fluid delivery systems are luer-type connecters, which generally include frustoconical surfaces configured for mating engagement between male and female parts.

### SUMMARY

An aspect of at least one of the embodiments disclosed herein includes the realization that connectors may be over-tightened or under-tightened, and/or may be too easy or too difficult to disconnect. For example, a connector may be over-tightened by a user because of concern about creating a sealed environment in a fluid delivery system. Such occurrences may be particularly prevalent among diabetics who sometimes suffer from conditions that cause numbness or tingling in hands and/or fingers, which can render difficult the manipulation of small objects and slick surfaces.

Over-tightening may cause a connector to fracture or break upon connection or disconnection. Additionally or alternatively, an over-tightened connector may be difficult to loosen or disconnect. Conversely, under-tightening may result in leakage due to failure to create a seal between connectors, unintentional disconnection, or both.

Thus, in accordance with at least one of the embodiments disclosed herein, a connector can comprise a body and gripping feature which facilitates or hampers tightening and/or loosening.

In accordance with some embodiments, a connector can comprise a body and a gripping feature. The gripping feature can comprise a first end proximal to a central portion of the connector and a second end distal to the central portion of the connector. The gripping feature can further comprise a surface that extends in a curved path, such as a spiral, between the first end and the second end.

In accordance with some embodiments, a connector can comprise a body having a first cavity near a proximal end of the body, a second cavity near a distal end of the body, the first and second cavities forming a passageway through the entire length of the body, threads for connecting to at least one other device, at least one tapered surface for mating with another device, a central axis, and at least one gripping feature. The gripping feature can comprise a surface extending primarily radially near the central axis, and primarily circumferentially near the gripping feature's radially distant end.

In accordance with some embodiments, a connector can comprise a body having a first cavity near a proximal end of the body, a second cavity near a distal end of the body, the first and second cavities forming a passageway through at least a portion of the body. The connector can include threads for connecting to at least one other device, and/or at least one tapered surface for mating with another device. The connector can include a central axis, and at least one gripping feature. The gripping feature can extend primarily radially near the central axis, and primarily circumferentially near the gripping feature's radially distant end. In some embodiments, the gripping feature can be asymmetrical about any plane which contains the central axis.

In accordance with some embodiments, a gripping feature can comprise a flange with at least one radially outwardly facing surface. The flange can extend from the body of the connector and have a median line running through its cross-section. The flange can have a proximal portion, with the median line of the proximal portion extending primarily radially from the central axis of the connector body. The flange can also have a distal portion, with the median line of the distal portion extending generally at an angle from the median line of the proximal portion.

In accordance with some embodiments, a gripping feature can generally comprise a flange with at least one radially outwardly facing surface, the flange being asymmetrical about any plane containing the central axis of the connector body.

In accordance with some embodiments, a gripping feature can comprise a flange with at least one radially outwardly and at least one radially inwardly facing surface. The flange can protrude from the connector body at an angle such that its distal end or tip is closer to the connector body than it is to the base of the flange.

In accordance with some embodiments, at least one gripping feature can comprise a first end proximal to a central portion of the body and a second end distal to the central portion of the body, the first end intersecting a first radial plane containing a central axis of the body, and the second end intersecting a second radial plane containing the central axis of the body, the first radial plane being different than the second radial plane such that the first and second ends are radially offset from one another.

In accordance with some embodiments, a connector can comprise a body and a gripping feature. The gripping feature can extend from the body, and can substantially flex and/or bend about the body so as to generally collapse around the body.

In accordance with some embodiments, a connector can comprise a body, a gripping feature, and a stop. The gripping feature can extend from the body, and can flex about the body when pressure is applied to the gripping feature. The stop can have at least one surface which inhibits the gripping feature from flexing in at least one direction.

In accordance with some embodiments, a connector can comprise a body and a gripping feature. The gripping feature can include at least one slot and/or opening, such that the connector has a generally uniform thickness of material throughout.

### BRIEF DESCRIPTION OF THE DRAWINGS

The above-mentioned and other features, aspects, and advantages of the inventions disclosed herein are described below with reference to drawings of one embodiment. The illustrated embodiment is intended to illustrate, but not limit, the inventions. The drawings contain the following figures:

FIG. 1 is a perspective view of an embodiment of a connector.

FIG. 2 is a side plan view of the embodiment of FIG. 1.

FIG. 3 is a cross-sectional view of the embodiment of FIG. 1 along line III-III, shown in FIG. 2.

FIG. 4 is a cross-sectional view of the embodiment of FIG. 1 along line IV-IV, shown in FIG. 2.

FIG. 5A is a cross-sectional view of an embodiment of a connector.

FIG. 5B is a cross-sectional view of an embodiment of a connector.

FIG. 5C is a cross-sectional view of an embodiment of a connector.

FIG. 5D is a cross-sectional view of the embodiment of FIG. 5C, with the gripping features in a flexed configuration.

FIG. 6A is a cross-sectional view of an embodiment of a connector.

FIG. 6B is a cross-sectional view of the embodiment of FIG. 6A, with the gripping features in a flexed configuration.

FIG. 6C is a cross-sectional view of an embodiment of a connector.

FIG. 7 is a cross-sectional view of an embodiment of a connector.

### DETAILED DESCRIPTION OF THE PREFERRED EMBODIMENTS

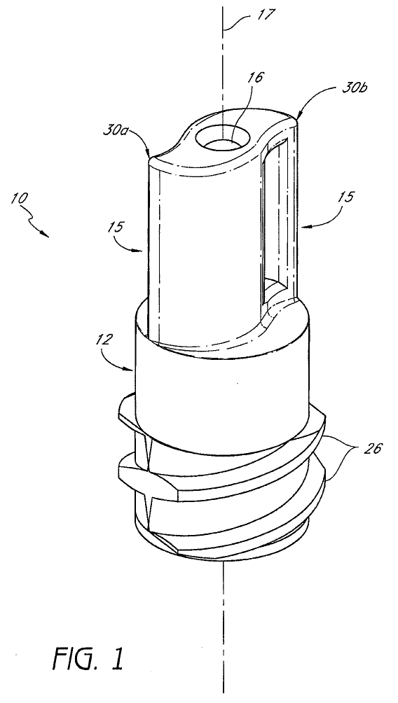

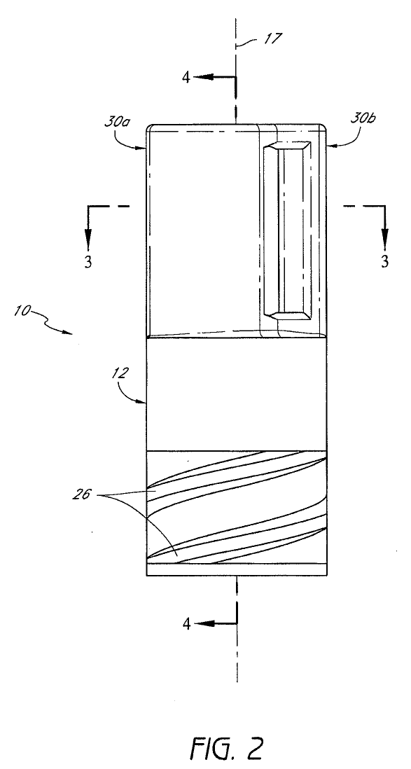

FIGS. 1-4 illustrate an embodiment of a connector 10. The illustrated connector 10 is a luer-type connector. However, other embodiments may comprise other types of connectors. The connectors can be formed from plastic, preferably polyethylene terephthalate (PET), polypropylene, or other types of plastic suitable for injection molding. For example, in at least one embodiment the connectors can be formed from polyvinyl chloride (PVC). Other materials can also be used, including but not limited to metal.

In the illustrated embodiment of FIGS. 1-4, the connector 10 comprises a body 12, a passageway 11, a fastener 13, and features 15 for gripping and rotating the connector to tighten or loosen the connector.

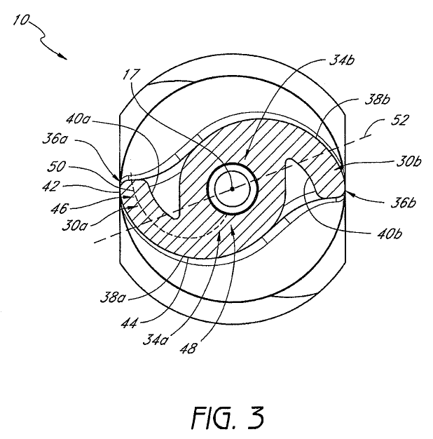

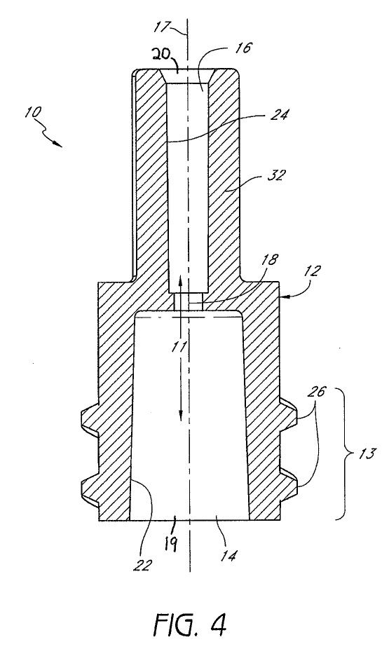

The passageway 11 can comprise one or more cavities. For example, the passageway 11 can comprise a first cavity 14 and a second cavity 16 that are disposed in proximity to opposite ends of the body, as shown in FIG. 4. In some embodiments, the first cavity 14 can comprise an opening 19 near or at an end of the body 12. Additionally or alternatively, the second cavity 16 can comprise an opening 20 near or at an end of the body 12. In some embodiments, the opening 19 of the first cavity 14 and the opening 20 of the second cavity 16 can be positioned near or at opposing ends of the body 12. In some embodiments, the connector can comprise more or fewer than two cavities. For example, the connector may comprise a single cavity, three cavities, or no cavity. In at least one embodiment, the connector 10 can comprise a plug, and/or the connector 10 can comprise a cap. The one or more cavities, if present, can permit fluid to flow through the connector 10.

The first cavity 14 of the illustrated embodiment has a slightly tapered surface 22. The tapered surface 22 can be sized and shaped to substantially mate with one or more complementary surfaces of another connector. In at least one embodiment, the connector 10 can conform to the ISO 594 standard for luer tapers. In yet other embodiments the connector 10 can have non-standard tapers. In at least one embodiment, the first cavity 14 can have geometries different than the geometry shown in the illustrated embodiment.

The second cavity 16 can be sized and shaped to receive a tube (not shown). The second cavity 16 can have a tapered surface 24 that facilitates bonding to the tube when the tube is inserted into the cavity 16. The second cavity 16 may have geometries different than the geometry shown in the illustrated embodiment.

The first cavity 14 and the second cavity 16 can be separated by a neck 18, as illustrated in FIG. 4. The neck 18 can serve one or more purposes. For example, the neck 18 can limit insertion of a tube into the cavity 16. Additionally or alternatively, the neck 18 may permit fluid to flow through the passageway 11 between the first cavity 14 and the second cavity 16. For example, in some embodiments the passageway 11 comprises an opening through which fluid flows from the first cavity 14 to the second cavity 16. In some embodiments, the opening extends through the entire length of the connector 10.

The flow rate of the fluid moving through passageway 11 can be related to the cross-sectional area of the passageway. The selection and design of the size and shape of the cross-section of the passageway 11 can affect the flow rate of fluid moving between the first and second cavities 14, 16. Thus, various sizes, shapes, and configurations of the cross-section, including but not limited to that shown in the illustrated embodiment, can be used.

The fastener 13 can attach the connector 10 to a fluid transfer device, such as a syringe or tube, having a complementary connector. With reference to FIG. 4, the fastener 13 of the connector 10 comprises partial threads 26. Alternatively, the fastener can comprise full threads, tabs, rings, or other structures capable of fastening the connector to a complementary connector. The threads can be single threads, double threads, or any other thread combination. As illustrated in FIG. 4, the threads 26 can be located on the exterior surface of the body 12. In some embodiments, the threads can be on an interior surface or surfaces of body 12.

In the embodiment illustrated in FIGS. 1-4, the threads 26 are configured such that a connection between the connector 10 and a complementary connector is tightened as the connector 10 is rotated relative to the complementary connector in a clockwise direction from the perspective of FIG. 3. In other embodiments, the connector 10 can comprise threads, or other fastener 13, that are configured such that a connection between the connector 10 and a complementary connector is tightened as the connector 10 is rotated relative to the complementary connector in a counter-clockwise direction from the perspective of FIG. 3. Nevertheless, if the connector 10 is not appropriately tightened to a complementary connector, the connection may leak or one or both of the connectors may break.

The gripping features 15 can facilitate manipulation, including rotation, of the connector 10. In various embodiments, the gripping features can comprise flanges, wings, protruding segments, recesses, and/or indentations located on or within the body of the connector. The gripping features can have curved and/or angled surfaces that can be engaged by fingers.

In the illustrated embodiment, the connector 10 comprises two of the gripping features 15. While the present embodiment has two gripping features, other embodiments can have only a single gripping feature or can have more than two gripping features. The gripping features 15 can be located near a central portion 32 of the body 12, which may surround the second cavity 16. In other embodiments, gripping features can be spaced from a central portion of the body.

The gripping features 15 can be elongate members that extend generally parallel to an axis of the connector, such as central axis 17, shown in FIGS. 1-3. In some embodiments, gripping features 15 can extend along approximately half of a length of the connector 10, while in other embodiments the gripping features can extend along more or less than half of the length of the connector. In the embodiment shown in FIGS. 1-4, the gripping features 15 extend along the majority of a length of the second cavity 16. However, in other embodiments the gripping features 15 can extend along all or a portion of a different portion of the body 12, such as the first cavity 14. Additionally, the gripping features can be of various sizes. For example, in some embodiments the outermost portions of the gripping features 15 can extend farther radially from a central axis 17 than does the body 12. With reference to FIG. 3, each gripping feature 15 can comprise a first end 34a, 34b that is proximal to the central portion 32 of the body 12 and a second end 36a, 36b that is distal to the central portion 32. Each gripping feature 15 generally comprises at least a first surface 38a, 38b and a second surface 40a, 40b. The first surface 38a, 38b and the second surface 40a, 40b can be arranged to be generally opposing.

The surfaces 38a and 38b can extend between the first ends 34a, 34b and the second ends 36a, 36b. The surfaces 38a, 38b can comprise one or more segments that are curved or generally flat. In some embodiments, the surfaces 38a, 38b can face radially outwardly, as illustrated in FIG. 3. The surfaces 38a, 38b can have at least a portion, or a group of portions, that is generally convex.

In some embodiments, each surface 38a, 38b of the gripping features 15 can have a distal segment 42 that is near the second end 36a, 36b, and a proximal segment 44 that is nearer to the first end 34a, 34b than is the distal segment 42. The surface area of the ends 36a, 36b can be narrow or substantially smaller than the surface area of the lateral surfaces 38a, 38b, such that a user's fingers would be less comfortable and/or more likely to slide off when gripping the ends than the lateral surfaces 38a, 38b. The distal segment 42 can extend in a direction that is generally circumferential about a central axis, while the proximal portion 44 can extend in a direction that has a greater radial component with respect to the central axis than does the direction of the distal portion 42. In some embodiments, as shown in FIG. 3, the distal segment 42 can extend primarily circumferentially around the central axis 17. In some embodiments, the proximal portion 44 can extend primarily radially from a center of the connector 10. In some embodiments, the proximal portion 44 can be near the first ends 34a, 34b.

In some embodiments, the surfaces 38a, 38b can extend in a generally spiral path between the first ends 34a, 34b and second ends 36a, 36b, as shown in FIG. 3. In some embodiments, as shown in FIGS. 1-4, the distal segment 42 can comprise the second end 36a, 36b of the gripping feature 15, and the second ends 36a, 36b can be substantially the farthest points measured radially from a central axis of the connector. In some embodiments, the gripping feature 15 does not have any portion that extends substantially farther from a central axis of the connector than does the distal segment 42. In some embodiments, the surface 38a, 38b can be generally convex and/or does not have any portion that is concave and located farther from a central axis of the connector than is the distal segment 42.

With reference to FIG. 3, the surfaces 40a and 40b of the gripping features 15 can extend between the first ends 34a, 34b and the second ends 36a, 36b. The surfaces 40a and 40b can comprise one or more segments that are curved or generally flat. The surfaces 40a, 40b can have at least a portion, or a group of portions, that is generally concave. In some embodiments, the surfaces 40a, 40b can face radially inwardly as illustrated in FIG. 3. In other embodiments, the surfaces 40a, 40b can face radially outwardly. In some embodiments, such as the embodiment of FIG. 3, the gripping feature 15 can comprise a flange 30a, 30b having a distal portion 46, a proximal portion 48, and a median line 50 extending between the first surface 38a, 38b and the second surface 40a, 40b at a location equidistant between them. The proximal portion 48 can be located near the central axis of the connector 17. The distal portion 46 can be located farther from the central axis 17 than the proximal portion 48. Through the proximal portion 48, the median line 50 can extend primarily radially from the central axis 17. Through the distal portion 46, the median line 50 can extend in a direction that is more circumferential than the direction of that portion of the median line which passes through the proximal portion 48.

In some embodiments, the gripping feature 15 can comprise a flange that is asymmetrical about any plane containing a central axis of the connector body. For example, as shown in FIG. 3, the flanges 30a, 30b are asymmetrical about a plane 52 and any other plane that contains the central axis 17. In some embodiments, the gripping feature 15 can comprise a first end 34a proximal to a central portion 32 of the body 12 and a second end 36a distal to the central portion 32 of the body 12, the first end 34a intersecting a first radial plane containing the central axis 17, and the second end 36a intersecting a second radial plane containing the central axis 17, the first radial plane being different than the second radial plane such that the first and second ends are radially offset from one another. In some embodiments the first radial plane intersects a portion of the first end 34a. For example, in some embodiments the first radial plane intersects a center portion of the first end 34a. In some embodiments, the second radial plane intersects a portion of the second end 36a. For example, in some embodiments the second radial plane intersects a center portion of the second end 36a.

Although in some embodiments the gripping feature or features 15 can comprise flanges, as indicated above, in other embodiments the gripping features 15 can have other configurations. For example, the gripping features 15 can comprise protrusions, wings, recesses, pockets, or grooves within at least a portion of the connector body. In some embodiments, a gripping feature 15 can comprise a protrusion that has a wave-like configuration with a thick base near a central axis of the connector body and a narrower tip. To connect or disconnect the connector 10, a user's fingers apply forces or pressure to the gripping features 15. The applied pressure can be considered to have a circumferential component, a normal component, and a tangential component. The circumferential component creates torque that turns the connector. The normal component contributes to friction that allows a user to maintain a grip on the connector while it is being manipulated, including turning. The tangential component, which acts in a direction along the contacted surface, can cause the user's fingers to slip relative to the contacted surface if they exceed the frictional force resulting from the normal component.

The torque required to turn the connector generally increases as the connector is tightened. Thus, the circumferential component of the applied pressure would need to be increased as the connector is tightened. A configuration of the connector in which pressure is applied against the surfaces 38a, 38b to tighten the connector, such as in the manner shown in FIGS. 1-4, can hamper a user's ability to tighten the connector. To tighten such a connector, a user can apply a pressure that has both a circumferential component that is sufficient to rotate the connector and a normal component that is sufficient to maintain the user's grip on the connector. Yet, a user's ability to apply pressure to the surfaces is limited. The configuration of surfaces 38a, 38b results in there being some required torque at which the maximum pressure applied by the user does not have both a normal component sufficient to maintain a grip and a circumferential component sufficient to overcome the required torque. In such a circumstance, application of a circumferential component that is sufficient to overcome the required torque also causes the tangential component to exceed the frictional force, which results in the user's fingers slipping off. Thus, the configuration of the surfaces 38a, 38b can reduce the incidence of over-tightening and the risk of damaging one or both connectors.

On the other hand, a configuration of the connector in which pressure is applied to some portion of the surfaces 40a, 40b, or to an area adjacent the surfaces 40a, 40b, to tighten the connector can facilitate a user's ability to tighten the connector. The configuration of the surfaces 40a, 40b tends to retain a user's finger in contact with the connector. For example, when a connector is being tightened by applying pressure to the surfaces 40a, 40b, the normal component required to maintain a grip on the connector generally will not increase as the connector is tightened. Instead, the gripping feature can provide support for the fingers. Thus, a greater component of the applied pressure can act in a circumferential direction to turn the connector, thereby facilitating tightening of the connector and reducing the occurrence of leakage.

In contrast to tightening, the torque required to rotate the connector generally decreases as a connector is loosened. Thus, the circumferential component of the applied force may be lessened as the connector is loosened. Nonetheless, the connectors cannot be rotated to loosen the connection until static friction is overcome.

A configuration of the connector in which pressure is applied against the surfaces 40a, 40b, or to an area adjacent the surfaces 40a, 40b, to loosen the connector, such as in the manner shown in FIGS. 1-4, can facilitate a user's ability to loosen the connector. As noted above, the configuration of the surfaces 40a, 40b tends to retain a user's finger in contact with the connector. Thus, a greater component of the applied pressure can act in a circumferential direction to turn the connector, thereby facilitating loosening of the connector.

On the other hand, a configuration of the connector in which pressure is applied against the surfaces 38a, 38b to loosen the connector, can hamper a user's ability to loosen the connector. As noted above, the configuration of the surfaces 38a, 38b limits a user's ability to rotate the connector against a required torque. Thus, the configuration of surfaces 38a, 38b can hamper the loosening of a connector. In some embodiments, the gripping features 15 can be configured to inhibit both tightening and loosening of the connector. For example, the gripping feature can have two surfaces that generally oppose each other and that each have a configuration of the type described above with reference to surfaces 38a, 38b. Such an embodiment can have a generally football-shaped cross-section.

In some embodiments, the gripping features 15 can be configured to facilitate both tightening and loosing of the connector. For example, the gripping feature can have two surfaces that generally oppose each other and that each have a configuration of the type described above with reference to surfaces 40a, 40b. One or more of the gripping features 15 disclosed herein can be applied to many other types of rotatable products, including other types of medical connectors or valves.

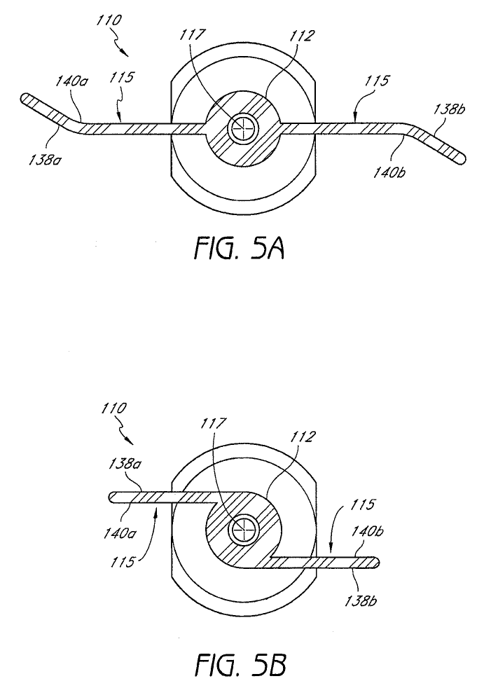

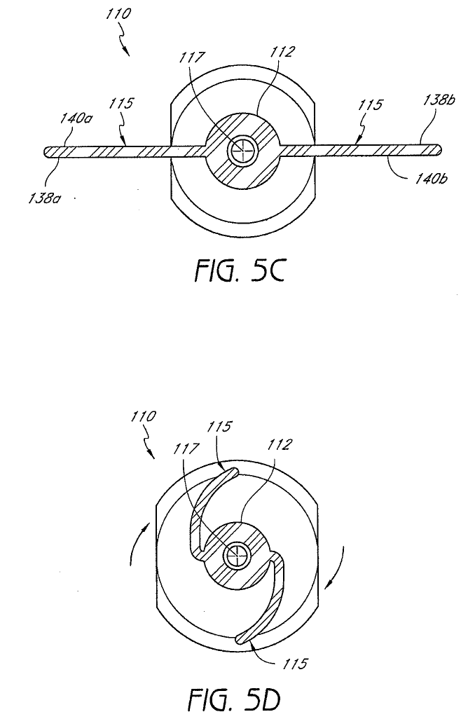

FIGS. 5A, 5B, 5C, and 5D illustrate embodiments of a connector 110. The connector 110 can be similar to the connector 10. Therefore, similar components of the connector 110 are referenced by the same reference numeral as the corresponding component in the connector 10 incremented by one hundred. As with the connector 10, the connector 110 can comprise a body 112, central axis 117, and features 115 for gripping and rotating the connector to tighten or loosen the connector.

Like the gripping features 15, the gripping features 115 can facilitate manipulation, including rotation, of the connector 110. In various embodiments, the gripping features can comprise flanges, wings, and/or protruding segments connected to the body 112 of the connector, either directly or indirectly. In some embodiments, the gripping features can be integrally formed with the body 112.

The gripping features 115 can differ from the gripping features 15 shown in FIG. 1, in some respects. For example, and with reference to FIG. 1, portions of the gripping features 15 nearest the partial threads 26 along axis 17 can generally be restrained from flexing relative to body 12 and axis 17 at least in part by their connection with the body 12 in this area. In contrast, the gripping features 115 shown in FIGS. 5A, 5B, 5C, and 5D can freely flex relative to body 112 and axis 117 in some embodiments. For example, the gripping features 115 can be flexed or twisted such that they collapse around the body 112 as shown in FIG. 5D (arrows indicating direction of movement). In some embodiments, the gripping features 115 can collapse against the body 112.

The gripping features 115 can have various cross-sectional profiles when unflexed. For example, the gripping features 115 can initially have a curved cross-sectional profile, as illustrated in FIG. 5A. With reference to FIGS. 5B and 5C, the gripping features 115 can alternatively have a generally straight cross-sectional profile. Other configurations are also possible. As described below, the ability of the gripping features 115 to flex and/or bend, as shown in FIG. 5D, can facilitate or hamper the tightening and/or loosening of the connector 110.

The torque required to turn the connector 110 can generally increase as the connector is tightened. Thus, the circumferential component of a pressure applied to the gripping features 115 would need to be increased as the connector is tightened. To tighten the connector 110, a user can apply a pressure that has both a circumferential component that is sufficient to rotate the connector and a normal component that is sufficient to maintain the user's grip on the connector. Yet, a user's ability to apply pressure to the surfaces of the gripping features 115 to turn the connector can be limited. For example, there can be some required torque at which the maximum pressure applied by the user does not have both a normal component sufficient to maintain a grip and a circumferential component sufficient to overcome the required torque. In such a circumstance, application of a circumferential component that is sufficient to overcome the required torque also causes the tangential component to exceed the frictional force, which results in the user's fingers slipping off.

With reference to FIGS. 5C and 5D, as pressure is applied to the surfaces 138a, 138b to turn the connector 110, the gripping features 115 can flex and/or bend in the direction the connector is being turned (see arrows in FIG. 5D). As the gripping features flex, the amount of force required to maintain a grip on the connector can increase, and the tangential force being applied by the user to turn the connector 110 can result in the user's fingers slipping off. Thus, in at least some embodiments, a user's ability to apply pressure to the surfaces of the gripping features 115 can be limited by the ability of the gripping features 115 to flex and/or bend. Where the user applies pressure to the surfaces 138a, 138b as shown in FIG. 5C to tighten the connector, the ability of the gripping features 115 to flex and/or bend can thus reduce the incidence of over-tightening and the risk of damaging the connector.

In at least some embodiments, the ability of the gripping features 115 to flex and/or bend can be greater in one direction than in another. With reference to FIG. 5A, in some embodiments the gripping features 115 can have a bent profile at their ends. As pressure is applied to the surfaces 140a, 140b, the bent ends of the gripping features 115 can at least initially straighten as the gripping features 115 bend or flex. Thus, the gripping features 115 can bend more quickly and easily when pressure is applied to surfaces 138a and 138b, as opposed to surfaces 140a and 140b. When the connector shown in FIG. 5A is being turned by applying pressure to the surfaces 140a, 140b, the gripping features 115 may only flex slightly, or not at all, and the normal component required to maintain a grip on the connector as the connector is turned can generally remain lower than if pressure is applied to surfaces 138a, 138b. Thus, a greater component of the applied pressure can act in a circumferential direction to turn the connector, resulting in increased support for the fingers and facilitating turning of the connector 110. Where the user applies pressure to the surfaces 140a, 140b as shown in FIG. 5A to tighten the connector, tightening can be facilitated and the occurrence of leakage can be reduced.

With continued reference to FIG. 5A, a configuration of the connector 110 in which pressure is applied against the generally concave surfaces 140a, 140b, or to an area adjacent the surfaces 140a, 140b, can facilitate a user's ability to loosen the connector. As noted above, the bent or angled profile of the gripping features 115 shown in FIG. 5A can tend to retain a user's finger in contact with the connector 110. Thus, a greater component of the applied pressure can act in a circumferential direction to turn the connector, thereby facilitating loosening of the connector. On the other hand, a configuration of the connector 110 in which pressure is applied against the generally convex surfaces 138a, 138b to loosen the connector, can hamper a user's ability to loosen the connector, since applying pressure to surfaces 138a, 138b causes the gripping features 115 to flex relative to the body 112.

With reference to FIG. 5B, in some embodiments the gripping features 115 can be offset from the central axis 117. In some embodiments, the gripping features 115 can bend more quickly and easily when pressure is applied to surfaces 138a and 138b, as opposed to surfaces 140a and 140b. When the connector shown in FIG. 5B is being turned by applying pressure to the surfaces 140a, 140b, the gripping features 115 may only flex slightly, or not at all, and the normal component required to maintain a grip on the connector as the connector is turned can generally remain lower than if pressure is applied to surfaces 138a, 138b. Thus, a greater component of the applied pressure can act in a circumferential direction to turn the connector, resulting in increased support for the fingers and facilitating turning of the connector 110. Where the user applies pressure to the surfaces 140a, 140b as shown in FIG. 5B to tighten the connector, tightening can be facilitated and the occurrence of leakage can be reduced.

With continued reference to FIG. 5B, a configuration of the connector 110 in which pressure is applied against the surfaces 140a, 140b, or to an area adjacent the surfaces 140a, 140b, can facilitate a user's ability to loosen the connector. As noted above, the offset nature of the gripping features 115 shown in FIG. 5B can tend to retain a user's finger in contact with the connector 110. Thus, a greater component of the applied pressure can act in a circumferential direction to turn the connector, thereby facilitating loosening of the connector. On the other hand, a configuration of the connector 110 in which pressure is applied against the surfaces 138a, 138b to loosen the connector can hamper a user's ability to loosen the connector, since applying pressure to surfaces 138a, 138b causes the gripping features 115 to flex relative to the body 112.

In some embodiments the gripping features 115 illustrated in FIG. 5B can be rigid, and substantially resist flexure. For example, the configuration of surfaces 138a, 138b in FIG. 5B results in there being some required torque at which the maximum pressure applied by the user does not have both a normal component sufficient to maintain a grip and a circumferential component sufficient to overcome the required torque. In such a circumstance, application of a circumferential component that is sufficient to overcome the required torque also causes the tangential component to exceed the frictional force, which is more likely to result in the user's fingers slipping off. Thus, the configuration of the surfaces 138a, 138b in FIG. 5B can reduce the incidence of over-tightening and the risk of damaging one or both connectors.

A configuration of the connector 110 in which pressure is applied to some portion of the surfaces 140a, 140b shown in FIG. 5B, or to an area adjacent the surfaces 140a, 140b, to tighten the connector can facilitate a user's ability to tighten the connector. The configuration of the surfaces 140a, 140b tends to retain a user's finger in contact with the connector. For example, when a connector is being tightened by applying pressure to the surfaces 140a, 140b, the normal component required to maintain a grip on the connector generally will not increase as the connector is tightened. Instead, the gripping feature can provide support for the fingers. Thus, a greater component of the applied pressure can act in a circumferential direction to turn the connector, thereby facilitating tightening of the connector and reducing the occurrence of leakage.

Similarly, a configuration of the connector 110 shown in FIG. 5B in which pressure is applied against the surfaces 140a, 140b, or to an area adjacent the surfaces 40a, 40b, to loosen the connector, can facilitate a user's ability to loosen the connector. On the other hand, a configuration of the connector 110 shown in FIG. 5B in which pressure is applied against the surfaces 138a, 138b to loosen the connector, can hamper a user's ability to loosen the connector.

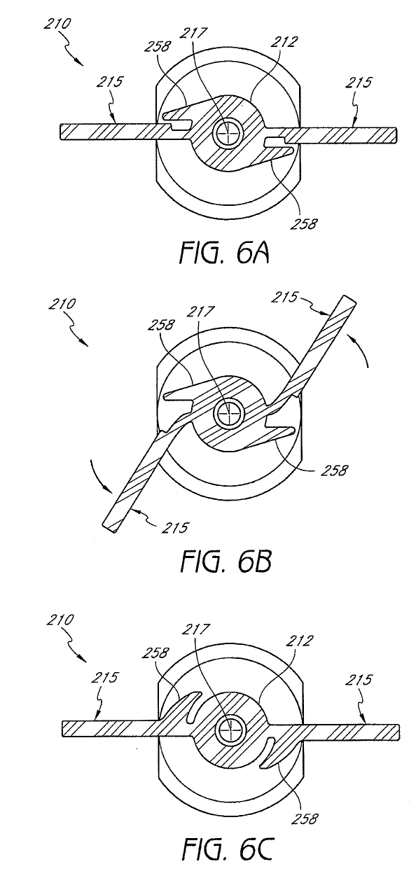

FIGS. 6A, 6B, and 6C illustrate embodiments of a connector 210. The connector 210 can be similar in many respects to the connectors 10 and 110. Therefore, similar components of the connector 210 are referenced by the same reference numeral as the corresponding component in the connector 10 incremented by two hundred. As with the connector 10, the connector 210 can comprise a body 212, a central axis 217, and features 215 for gripping and rotating the connector to tighten and/or loosen the connector.

With reference to FIGS. 6A, 6B, and 6C, the gripping features 215 can extend from a portion of the body 212. The gripping features 215 can have various configurations, including but not limited to those illustrated in FIGS. 6A, 6B, and 6C.

The connector 210 can include stops 258. In at least one embodiment, the stops 258 can be formed integrally with the body 212, as illustrated in FIGS. 6A and 6B. The stops can comprise at least one portion protruding generally radially away from the body 212 and alongside a portion of the gripping features 215. The stops 258 can inhibit or prevent the gripping features 215 from flexing and/or bending in at least one direction. For example, as the gripping feature 215 flexes in a counterclockwise direction (see arrow in FIG. 6B), the gripping features 215 can freely flex without being inhibited by one of the stops. In contrast, as the gripping feature 215 is flexed in a clockwise direction, the gripping feature 215 can encounter stop 258, and be inhibited from further flexion.

Configurations and geometries for the stops 258 other than those illustrated in FIGS. 6A and 6B are also possible. For example, the stops 258 can be incorporated on, or form a part of, the gripping features 215 themselves, as illustrated in FIG. 6C. Thus, in the embodiment illustrated in FIG. 6C, contact between the stops 258 and the body 212 can prevent further flexing of the gripping features 215 in one or more directions, rather than contact between the gripping features 215 and the stops 258 restricting flexion.

In embodiments wherein the gripping features 215 are able to flex and/or bend, overtightening and/or loosening can be hampered, as with the connector 110. By incorporating stops 258, the flexing and/or bending can be controlled such that the gripping features 215 are able to flex and/or bend when the connector 210 is turned in one direction, but are generally inhibited or prevented from flexing and/or bending when turned in another direction.

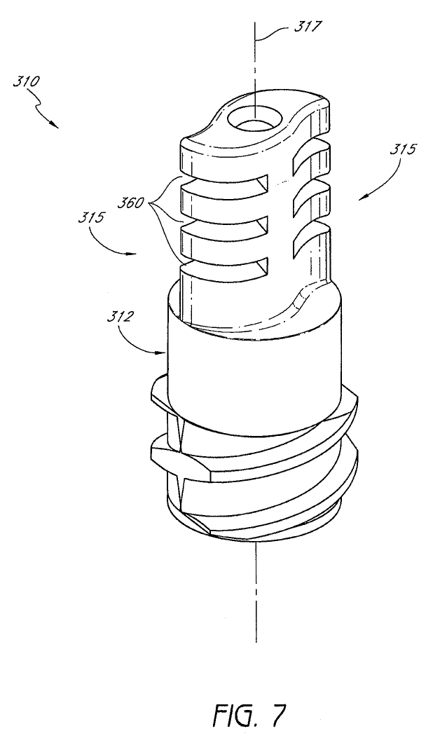

FIG. 7 illustrates an embodiment of a connector 310. The connector 310 is similar in many respects to the connectors 10, 110, and 210. Therefore, similar components of the connector 310 are referenced by the same reference numeral as the corresponding component in the connector 10 incremented by three hundred. As with the connector 10, the connector 310 can comprise a body 312, a central axis 317, and features 315 for gripping and rotating the connector to tighten and/or loosen the connector.

With reference to FIG. 7, the connector 310 can include at least one slot 360. In some embodiments, the slot 360 can extend entirely through a portion of the connector 310. In some embodiments, the connector 310 can include a series of slots 360 extending through a portion or portions of the gripping features 315. The slots 360 can aid in the manufacturing process by ensuring relatively uniform thickness of material throughout the connector 310, preventing warping, and facilitating accurate molding. Relatively uniform thicknesses of material can aid in the injection molding process by preventing unwanted warping of the connector material.

In some embodiments, the gripping features 15, 115, 215, and 315 described above can be comprised of different material than the body of the connector, and/or be separate components. For example, in some embodiments the gripping features 115 can be comprised of a more flexible and/or soft material than that of the body of the connector.

Of course, it is to be understood that not necessarily all objectives or advantages described may be achieved in accordance with any particular embodiment described herein. Also, although the invention has been disclosed in the context of certain embodiments and examples, it will be understood by those skilled in the art that the invention extends beyond the specifically disclosed embodiments to other alternative embodiments and/or uses and obvious modifications and equivalents thereof. Some embodiments can include one or more features described in connection with one or more of the embodiments described herein. For example, the stops 258 shown in FIGS. 6A-6C can be used with the connector 10 shown in FIGS. 1-4, and with the connectors 110 shown in FIGS. 5A-5D. The slot 360 shown in FIG. 7 can be used with the connectors 10 shown in FIGS. 1-4, with the connectors 110 shown in FIGS. 5A-5D, and with the connectors 210 shown in FIGS. 6A-6C. Additionally, in some embodiments a connector can include one or more different types of gripping features. For example, the connector can include one or more of the gripping features shown in FIGS. 1-4, plus one or more gripping features shown in FIGS. 5A-D, 6A-C, and FIG. 7. Accordingly, the invention is not intended to be limited by the specific disclosures of preferred embodiments herein.

The following is claimed:

1. A medical connector for rotational interaction with a device, the medical connector comprising:
a body comprising a first cavity near a proximal end of the body, and a second cavity near a distal end of the body, the first and second cavities forming a passageway through at least a portion of a length of the body;
a central axis extending through the body; and
a gripping feature extending from at least a portion of the body, the gripping feature extending primarily radially near the central axis, and primarily circumferentially near the gripping feature's radially distant end;
wherein the gripping feature extends asymmetrically about any plane containing the central axis.

2. The medical connector of claim 1, further comprising threads for connecting the connector device to at least one other device.

3. The medical connector of claim 1, further comprising at least one tapered surface for mating the connector device with a device.

4. The medical connector of claim 1, wherein the gripping feature is generally free to substantially flex relative to the body and central axis.

5. The medical connector of claim 1, wherein the gripping feature extends axially along a portion of the body of the connector.

6. The medical connector of claim 1, wherein the gripping feature has at least one substantially curved surface.

7. The medical connector of claim 1, further comprising at least one additional gripping feature extending from the body.

8. The medical connector of claim 1, wherein the gripping feature comprises a proximal portion, with a median line of the proximal portion extending primarily radially from the central axis, and a distal portion with a median line of the distal portion extending generally at an angle from the median line of the proximal portion.

9. The medical connector of claim 1, wherein the gripping feature comprises a flange with at least one radially outwardly facing surface, the flange being asymmetrical about any plane containing the central axis.

10. The medical connector of claim 1, wherein the gripping feature comprises a flange with at least one radially outwardly and at least one radially inwardly facing surface.

11. The medical connector of claim 1, wherein the gripping feature protrudes from the connector body at an angle such that a distal end of the gripping feature is closer to the connector body than to a base of the gripping feature.

12. The connector of claim 1, wherein the gripping feature further comprises at least one slot extending entirely through a portion of the connector.

13. The medical connector of claim 1, wherein the gripping feature is comprised of different material than the body.

14. A rotatable medical connector comprising:
a body;
at least one gripping feature extending from the body, the at least one gripping feature comprising a first substantially convex surface and a second substantially concave surface on a generally opposing side thereof;
wherein the substantially convex surface provides substantially greater finger contact area than the substantially concave surface, such that the connector is configured to diminish the risk of over-tightening and increase the ease of loosening the connector from another medical device.

15. The rotatable connector of claim 14, wherein the gripping feature comprises a first end proximal to a central portion of the body and a second end distal to the central portion of the body, the first end intersecting a first radial plane containing a central axis of the body, and the second end intersecting a second radial plane containing the central axis of the body, the first radial plane being different than the second radial plane such that the first and second ends are radially offset from one another.

16. The rotatable connector of claim 14, wherein the gripping feature extends axially along a portion of the body.

17. The rotatable connector of claim 14, wherein the gripping feature is generally free to substantially flex relative to the body and central axis.

18. The rotatable connector of claim 14, further comprising at least one additional gripping feature extending from the body.

19. A rotatable connector comprising:
a body;
at least one gripping feature extending from the body;
wherein the gripping feature is substantially flexed about the body when pressure is applied to at least one surface of the gripping feature.

20. The rotatable connector of claim 19, wherein the gripping feature is configured to substantially collapse about the body when pressure is applied to at least one surface of the gripping feature.

21. The rotatable connector of claim 19, wherein the gripping feature is generally inhibited from flexing in one direction and free to move in another, opposite direction.

22. The rotatable connector of claim 21, wherein the gripping feature has a generally curved cross-sectional profile.

23. The rotatable connector of claim 21, further comprising a second gripping feature.

24. The rotatable connector of claim 21, wherein the first and second gripping features both initially extend radially from a central axis of the body.

25. The rotatable connector of claim 21, wherein the rotatable connector device comprises a stop having at least one surface which inhibits the gripping feature from flexing in at least one direction.

26. The rotatable connector of claim 25, wherein the stop extends from the body.

27. The rotatable connector of claim 25, wherein the stop extends from the gripping feature.
